(19) United States
(12) Patent Application Publication
(10) Pub. No.: US 2026/0238877 A1
(43) Pub. Date: Aug. 13, 2026

(54) ELECTRONIC DEVICE, AND CONTROL METHOD

(71) Applicant: CANON KABUSHIKI KAISHA, Tokyo (JP)

(72) Inventor: Yasuhiro KUWABARA, Tochigi (JP)

(21) Appl. No.: 19/464,762

(22) Filed: Jan. 30, 2026

(30) Foreign Application Priority Data
Feb. 3, 2025 (JP) 2025-015885

(51) Int. Cl. H04N 23/62; G06F 3/04817; G06F 3/0482; H04N 23/63

(52) U.S. Cl. CPC H04N 23/62; G06F 3/04817; G06F 3/0482; H04N 23/632

(57) ABSTRACT

An electronic device according to the present disclosure is capable of performing a first setting in which (1) in a first state where the electronic device is in a horizontal orientation, an item is displayed at a first position on an end side in a first direction that is a right direction or a left direction in the first state, (2) in a second state where the electronic device is in a first vertical orientation, the item is displayed at the first position on an end side in a second direction that is an up direction or a down direction in the second state, and (3) in a third state where the electronic device is in a second vertical orientation that is vertically opposite to the first vertical orientation, the item is displayed at a second position on an end side in the second direction in the third state.

### BACKGROUND

### Field of the Technology

The present disclosure relates to an electronic device and particularly relates to a display control of a setting screen.

### Description of the Related Art

A camera that can set a position on a grip side of the camera and a position on a side opposite to the grip side as a display position of an item such as a setting item displayed by a display device of the camera is known. The position on the grip side may be interpreted as a position on a right end side when a camera in a horizontal orientation is seen from a back side, and the position on the side opposite to the grip side may be interpreted as a position on a left end side when the camera in the horizontal orientation is seen from the back side.

The camera may be used in a vertical orientation. The camera has a substantially quadrangular shape having a longitudinal direction (long side) and a transverse direction (short side) when seen from a shooting direction (an optical axis direction of a lens). The horizontal orientation is an orientation where the longitudinal direction is a left-right direction and the transverse direction is an up-down direction. The vertical orientation is an orientation where the longitudinal direction is the up-down direction and the transverse direction is the left-right direction, and is an orientation of the camera where the camera in the horizontal orientation is rotated by 90 degrees or 270 degrees with respect to the shooting direction as an axis.

Japanese Patent Laid-Open No. 2023-88095 discloses a technique of causing a direction of a shot image and a direction of a display item to match with each other based on an arrangement aspect of display items, a direction of a display screen, and an orientation of a display device. Japanese Patent Laid-Open No. 2015-95085 discloses a technique in which, when an image display unit is rotated, a direction of an image is rotated to change between functions during four-direction operations of an operation button without rotating a menu.

However, a suitable display position of an item depends on a preference of a user and may vary between the horizontal orientation and the vertical orientation. In the related art such as the technique disclosed in Japanese Patent Laid-Open No. 2023-88095 or the technique disclosed in Japanese Patent Laid-Open No. 2015-95085, the item may not be displayed at the suitable position.

### SUMMARY

The present disclosure provides a technique capable of reliably and easily displaying an item at a suitable position.

An electronic device according to the present disclosure is an electronic device that includes a display device, the electronic device including a processor, and a memory storing a program which, when executed by the processor, causes the electronic device to execute acquisition processing of acquiring information regarding an orientation of the electronic device, execute setting processing of performing setting regarding a display position of an item, and execute control processing of performing control such that the item is displayed at a position of the display device based on the information acquired by the acquisition processing and the setting performed by the setting processing, wherein in the setting processing, it is capable of performing a first setting in which (1) in a first state where the electronic device is in a horizontal orientation, the item is displayed at a first position on an end side in a first direction that is a right direction or a left direction in the first state, (2) in a second state where the electronic device is in a first vertical orientation, the item is displayed at the first position on an end side in a second direction that is an up direction or a down direction in the second state, and (3) in a third state where the electronic device is in a second vertical orientation that is vertically opposite to the first vertical orientation, the item is displayed at a second position on an end side in the second direction in the third state.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are external views illustrating a digital camera.

FIG. 2 is a block diagram illustrating the digital camera.

FIG. 3 is a flowchart illustrating menu screen processing.

FIG. 4 is a flowchart illustrating display position setting screen processing.

FIG. 5 is a flowchart of shooting screen processing.

FIG. 6 is a flowchart illustrating display processing based on a display position setting.

FIGS. 7A to 7C are schematic diagrams illustrating a quick setting screen.

FIGS. 8A to 8F are schematic diagrams illustrating a quick menu screen.

FIGS. 9A and 9B are schematic diagrams illustrating a display position setting screen.

FIGS. 10A to 10F are schematic diagrams illustrating an orientation of a display unit.

FIGS. 11A and 11B are schematic diagrams illustrating a quick menu display.

### DESCRIPTION OF THE EMBODIMENTS

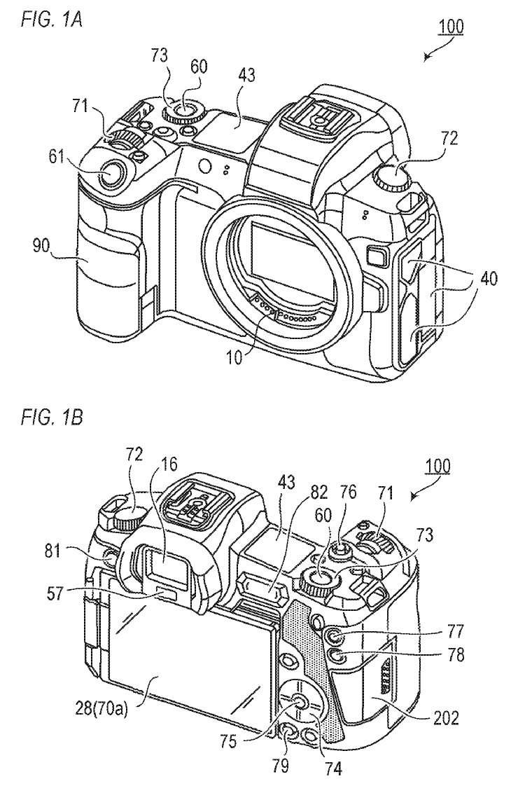

An embodiment of the present disclosure will be described. FIGS. 1A and 1B are external views illustrating a digital camera 100 (imaging device) as an example of an electronic device to which the present disclosure can be applied. FIG. 1A is a front perspective view illustrating the digital camera 100 and FIG. 1B is a back perspective view illustrating the digital camera 100.

A display unit 28 is a display unit (display device) provided on a back surface of the digital camera 100 and displays an image and various types of information. A touch panel 70a can detect a touch operation on a display surface (touch operation surface) of the display unit 28. An outer finder display unit 43 is a display unit provided on an upper surface of the digital camera 100 and displays various setting values of the digital camera 100 including a shutter speed and an aperture. A shutter button 61 is an operation member for giving a shooting instruction. A mode selector switch 60 is an operation member for switching between various modes. A terminal cover 40 is a cover that protects a connector (not illustrated) that connects the digital camera 100 to an external device.

A main electronic dial 71 is a rotation operation member, and a change in a setting value such as a shutter speed or an aperture or the like can be executed by turning the main electronic dial 71. A power switch 72 is an operation member for switching between ON and OFF of a power supply of the digital camera 100. A sub-electronic dial 73 is a rotation operation member. By turning the sub-electronic dial 73, movement of a selection frame (cursor), image feeding, or the like can be executed. A four-direction key 74 is configured to be pressable at each of upper, lower, left, and right portions, and processing corresponding to a pressed portion of the four-direction key 74 can be executed. A SET button 75 is a push button and is mainly used to determine a selection item.

A moving image button 76 is used for an instruction to start or stop moving image shooting (recording). An AE lock button 77 is a push button. By pressing the AE lock button 77 in a shooting standby state, an exposure state can be fixed. An enlargement button 78 is an operation button for switching between ON and OFF of an enlargement mode in live view display (LV display) of a shooting mode. By turning ON the enlargement mode and then operating the main electronic dial 71, a live view image (LV image) can be enlarged or reduced. In a reproduction mode, the enlargement button 78 functions as an operation button for enlarging a reproduction image or increasing its enlargement ratio. A reproduction button 79 is an operation button for switching between the shooting mode and the reproduction mode. During the shooting mode, the mode shifts to the reproduction mode by pressing the reproduction button 79, and a latest image among images recorded in a recording medium 200 (described below) can be displayed on the display unit 28. A menu button 81 is a push button used to execute an instruction operation of displaying a menu screen. When the menu button 81 is pressed, a menu screen on which various settings can be executed is displayed on the display unit 28. A user can execute various settings intuitively by using the menu screen displayed on the display unit 28, the four-direction key 74, and the SET button 75.

A touch bar 82 is a linear touch operation member (line touch sensor) that can receive a touch operation. The touch bar 82 is located at a position that enables a touch operation (touchable) with the thumb finger of the right hand in a state in which a grip portion 90 is gripped with the right hand (a state in which the grip portion 90 is gripped with the little finger, the ring finger, and the middle finger of the right hand) such that the shutter button 61 can be pressed by the index finger of the right hand. That is, the touch bar 82 is located at a position where the touch bar 82 can be operated in a state in which the user approaches to an eyepiece viewfinder with the eyes, looks through an eyepiece portion 16, and holds up the digital camera so as to be able to press a shutter button 61 at any time (shooting orientation). The touch bar 82 can receive a tapping operation on the touch bar 82 (an operation of touching the touch bar and releasing the touch bar without moving the touch position within a predetermined period of time), a sliding operation to the left or right (an operation of touching the touch bar and then moving the touch position while keeping the touch), and the like. The touch bar 82 is an operation member that is different from the touch panel 70a and does not have a display function. The touch bar 82 functions as, for example, a multi-function bar (M-Fn bar) to which various functions can be allocated.

A communication terminal 10 is a communication terminal that causes the digital camera 100 to execute communication with a lens unit 150 (described below; detachable) side. The eyepiece portion 16 is an eyepiece portion of the eyepiece viewfinder (viewing-type finder), and the user can view a video displayed in an EVF 29 (described below; an electronic viewfinder) via the eyepiece portion 16. An eyepiece detection unit 57 is an eyepiece detection sensor which detects whether an eye of the user (person who performs shooting) approaches the eyepiece portion 16. A lid 202 is a lid of a slot that stores a recording medium 200 (described below). The grip portion 90 is a holding portion formed into a shape allowing the user to easily grip the grip portion 90 with the right hand when the user holds up the digital camera 100. The shutter button 61 and the main electronic dial 71 are located at positions enabling the user to operate the shutter button 61 and the main electronic dial 71 with the index finger of the right hand in a state in which the user holds the digital camera 100 while gripping the grip portion 90 with the little finger, the ring finger, and the middle finger of the right hand. Further, in the same state, the sub-electronic dial 73 and the touch bar 82 are located at positions enabling the user to operate the sub-electronic dial 73 and the touch bar 82 with the thumb finger of the right hand.

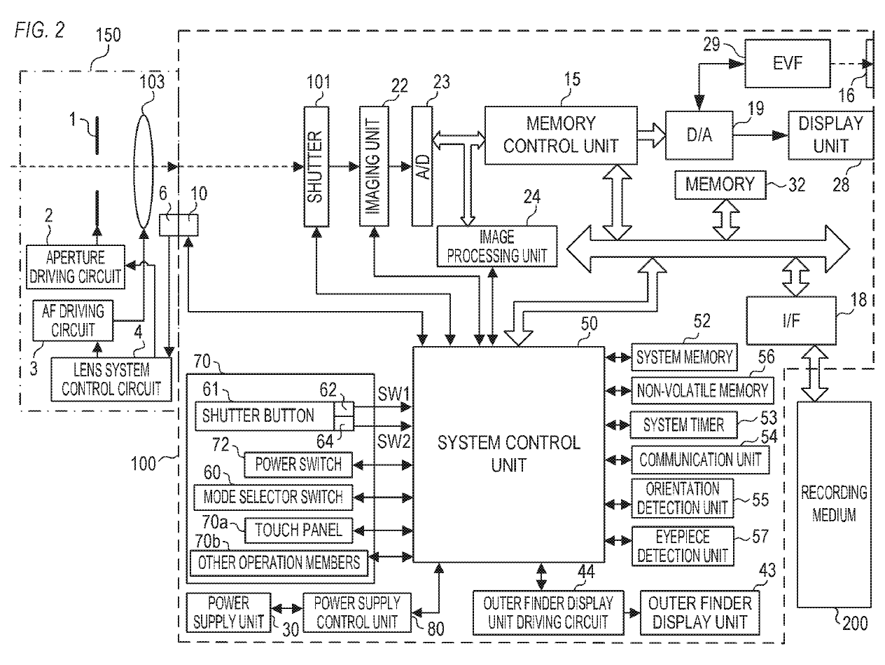

FIG. 2 is a block diagram illustrating a configuration example of the digital camera 100. The lens unit 150 is a lens unit on which an interchangeable imaging lens is mounted. A lens bis usually configured with a plurality of lenses, but only one lens in a simplified manner is illustrated in FIG. 2. A communication terminal 6 is a communication terminal that allows the lens unit 150 to communicate with the digital camera 100 side. The communication terminal 10 is a communication terminal that allows the digital camera 100 to communicate with the lens unit 150 side. The lens unit 150 communicates with a system control unit 50 via the communication terminals 6 and 10. The lens unit 150 executes controlling an aperture 1 via an aperture driving circuit 2 by a lens system control circuit 4. The lens unit 150 executes focusing by displacing a position of the lens 103 via an AF driving circuit 3 by the lens system control circuit 4.

A shutter 101 is a focal plane shutter that can freely control an exposure time of an imaging unit 22 under the control of the system control unit 50.

The imaging unit 22 is an imaging element (image sensor) configured with a CCD, a CMOS element, or the like which converts an optical image into an electrical signal. The imaging unit 22 may include an imaging-plane phase-difference sensor that outputs defocus amount information to the system control unit 50. An A/D converter 23 converts an analog signal output from the imaging unit 22 into a digital signal.

An image processing unit 24 executes predetermined processing (pixel interpolation, resizing processing such as reduction, color conversion processing, or the like) on data from the A/D converter 23 or data from a memory control unit 15. The image processing unit 24 executes predetermined arithmetic processing by using captured image data, and the system control unit 50 executes exposure control and distance measurement control based on a calculation result obtained by the image processing unit 24. Accordingly, through-the-lens (TTL) type autofocus (AF) processing, auto exposure (AE) processing, flash pre-emission (EF) processing, and the like are executed. The image processing unit 24 executes predetermined arithmetic processing by using the captured image data and executes TTL-type auto white balance (AWB) processing based on the obtained calculation result.

The memory control unit 15 controls transmission and reception of data among the A/D converter 23, the image processing unit 24, and a memory 32. Output data from the A/D converter 23 is written into the memory 32 via the image processing unit 24 and the memory control unit 15. Alternatively, the output data from the A/D converter 23 is written into the memory 32 via the memory control unit 15 without the intervention of the image processing unit 24. The memory 32 stores the image data that is obtained by the imaging unit 22 and is converted into digital data by the A/D converter 23 and image data to be displayed on the display unit 28 or the EVF 29. The memory 32 has a storage capacity that is sufficient for storing a predetermined number of still images and moving image and voice in a predetermined period of time.

The memory 32 also serves as a memory (video memory) for image display. A D/A converter 19 converts image data for display stored in the memory 32 into an analog signal and supplies the analog signal to the display unit 28 or the EVF 29. In this way, the image data for display that is written in the memory 32 is displayed by the display unit 28 or the EVF 29 via the D/A converter 19. Each of the display unit 28 and the EVF 29 is a display (display device) such as an LCD or an organic EL and executes display corresponding to an analog signal from the D/A converter 19. By causing the D/A converter 19 to convert digital signals A/D-converted by the A/D converter 23 and accumulated in the memory 32 into analog signals and sequentially transferring the analog signals and displaying the analog signals on the display unit 28 or the EVF 29, it is possible to execute live view display (LV). Hereinafter, an image displayed in the live view display is referred to as a live view image (LV image).

The system control unit 50 is a control unit including at least one processor and/or at least one circuit, and controls the entire digital camera 100. The system control unit 50 serves as a processor and also a circuit. The system control unit 50 implements each process according to an embodiment described below by executing a program recorded in a non-volatile memory 56. The system control unit 50 also executes display control by controlling the memory 32, the D/A converter 19, the display unit 28, the EVF 29, and the like.

A system memory 52 is, for example, a RAM. The system control unit 50 loads constants, variables, programs read from the non-volatile memory 56, and the like for an operation of the system control unit 50 on the system memory 52.

The non-volatile memory 56 is an electrically erasable and recordable memory and is, for example, an EEPROM. In the non-volatile memory 56, the constants, the programs, and the like for operations of the system control unit 50 are recorded. The programs as used herein are programs for executing various flowcharts described below according to the present embodiment.

A system timer 53 is a timer unit that counts time used for various controls and time of an embedded clock.

A communication unit 54 transmits and receives a video signal and a voice signal to and from an external device connected thereto wirelessly or via a wired cable. The communication unit 54 can also be connected to a wireless local area network (LAN) and the Internet. The communication unit 54 can also communicate with an external device through Bluetooth (registered trademark) or Bluetooth Low Energy. The communication unit 54 can transmit an image (including an LV image) shot by the imaging unit 22 and an image recorded on the recording medium 200 and can receive image data and other various types of information from an external device.

An orientation detection unit 55 detects an orientation of the digital camera 100 with respect to the direction of gravity. Based on the orientation detected by the orientation detection unit 55, it can be determined whether an image shot by the imaging unit 22 is an image shot with the digital camera 100 held horizontally or an image shot with the digital camera 100 held vertically. The system control unit 50 can add direction information corresponding to the orientation detected by the orientation detection unit 55 to an image file of the image shot by the imaging unit 22, or rotate and record the image. In addition, the system control unit 50 can also change a direction or a position of an item displayed on the display unit 28. An acceleration sensor, a gyro sensor, or the like can be used as the orientation detection unit 55. A movement of the digital camera 100 (whether the digital camera 100 is panning, tilting, lifting, stationary, or the like) can also be detected using an acceleration sensor or a gyro sensor that is the orientation detection unit 55.

The eyepiece detection unit 57 is an eyepiece detection sensor that detects approach (eye approach) and separation (eye separation) of an eye with respect to the eyepiece portion 16 of the eyepiece viewfinder (hereinafter, simply referred to as a “finder”). The system control unit 50 switches between display (display state) and non-display (non-display state) of each of the display unit 28 and the EVF 29 according to the state detected by the eyepiece detection unit 57. More specifically, when at least the shooting standby state is established and a switching setting for a display destination is set to automatic switching, while eye approach is not detected, the display is turned on with the display destination set as the display unit 28, and the EVF 29 executes non-display. While eye approach is detected, the display is turned on with the display destination set as the EVF 29, and the display unit 28 executes non-display. For example, an infrared proximity sensor can be used as the eyepiece detection unit 57, which allows detection of the approach of any object to the eyepiece portion 16 of the finder incorporating the EVF 29. When an object approaches the eyepiece portion, infrared light emitted from a light-emitting unit (not illustrated) of the eyepiece detection unit 57 is reflected from the object and is received by a light-receiving unit (not illustrated) of the infrared proximity sensor. A distance from the eyepiece portion 16 to the object (eye-approach distance) can also be determined based on the amount of the received infrared light. In this way, the eyepiece detection unit 57 executes eye approach detection for detecting the approach distance of the object to the eyepiece portion 16. When an object which approaches the eyepiece portion 16 within a predetermined distance is detected from the non-eye-approach state (non-approach state), it is detected that the eye approaches the eyepiece portion. It is assumed that, when the object of which the approach is detected is separated from the eye-approach state (approach state) by a predetermined distance or more, it is detected that the eye is separated from the eyepiece portion. A threshold value for detecting eye approach and a threshold value for detecting eye separation may be set to be different by providing, for example, a hysteresis. After the eye approach is detected, the eye-approach state is assumed until the eye separation is detected. After the eye separation is detected, the non-eye-approach state is assumed until the eye approach is detected. The infrared proximity sensor is exemplary, and another sensor may be adopted as the eyepiece detection unit 57 as long as the sensor can detect a state that can be regarded as eye approach.

Various setting values of the camera including the shutter speed and the aperture are displayed on the outer finder display unit 43 via an outer finder display unit driving circuit 44.

A power supply control unit 80 includes a battery detection circuit, a DC-DC converter, and a switch circuit that switches a block to be electrified, and detects whether a battery is mounted, a type of battery, a remaining battery level, or the like. The power supply control unit 80 controls the DC-DC converter based on a result of the detection and an instruction from the system control unit 50, and supplies a required voltage to units including the recording medium 200 for a necessary period of time. A power supply unit 30 includes a primary battery such as an alkaline battery or a lithium battery, a secondary battery such as a NiCd battery, a NiMH battery, or a lithium ion battery, an AC adapter, or the like.

A recording medium I/F 18 is an interface with the recording medium 200 such as a memory card or a hard disk. The recording medium 200 is a recording medium such as a memory card for recording a shot image and is configured with a semiconductor memory and a magnetic disk.

An operation unit 70 is an input unit that receives an operation from the user (user operation) and is used for inputting various operation instructions to the system control unit 50. As illustrated in FIG. 2, the operation unit 70 includes the shutter button 61, the mode selector switch 60, the power switch 72, the touch panel 70a, other operation members 70b, and the like. The other operation members 70b include the main electronic dial 71, the sub-electronic dial 73, the four-direction key 74, the SET button 75, the moving image button 76, the AE lock button 77, the enlargement button 78, the reproduction button 79, the menu button 81, the touch bar 82, and the like.

The shutter button 61 includes a first shutter switch 62 and a second shutter switch 64. The first shutter switch 62 is turned ON during an operation of the shutter button 61, that is, a so-called half push (shooting preparation instruction), to generate a first shutter switch signal SW1. The system control unit 50 starts a shooting preparation operation such as autofocus (AF) processing, auto exposure (AE) processing, auto white balance (AWB) processing, or flash pre-emission (EF) processing by the first shutter switch signal SW1. The second shutter switch 64 is turned ON by completion of the operation of the shutter button 61, that is, a so-called full push (shooting instruction), to generate a second shutter switch signal SW2. The system control unit 50 starts a series of shooting processing operations from reading a signal from the imaging unit 22 to writing a shot image as an image file into the recording medium 200, with the second shutter switch signal SW2.

The mode selector switch 60 switches an operation mode of the system control unit 50 to any of a still image shooting mode, a moving image shooting mode, and a reproduction mode. Examples of the still image shooting mode include an auto shooting mode, an auto scene determination mode, a manual mode, an aperture-priority mode (Av mode), a shutter-speed priority mode (Tv mode), and a program AE mode (P mode). In addition, examples thereof also include various scene modes and custom modes serving as shooting settings for each shooting scene. A user can directly switch the operation mode to any one of these modes with the mode selector switch 60. Alternatively, the user may temporarily switch a screen to a list screen of a shooting mode with the mode selector switch 60 and then selectively switch the mode to any one of the plurality of displayed modes with another operation member. Similarly, the moving image shooting mode may include a plurality of modes.

The touch panel 70a is a touch sensor that detects any of various touch operations on a display surface of the display unit 28 (an operation surface of the touch panel 70a). The touch panel 70a and the display unit 28 can be formed to be integrated with each other. For example, the touch panel 70a is configured so that transmittance of light does not hinder display of the display unit 28, and is attached to an upper layer of the display surface of the display unit 28. Input coordinates on the touch panel 70a are associated with display coordinates on the display surface of the display unit 28. Accordingly, it is possible to provide a graphical user interface (GUI) configured as if the user can directly operate a screen displayed on the display unit 28.

The system control unit 50 can detect the following operations on the touch panel 70a or the following states of the touch panel 70a.

An operation in which a finger or a pen that has not touched the touch panel 70a newly touches the touch panel 70a, that is, a start of a touch (hereinafter, referred to as touch-down).

A state where a finger or a pen is touching the touch panel 70a (hereinafter, referred to as touch-on).

An operation in which a finger or a pen is moving while touching the touch panel 70a (hereinafter, referred to as touch-move).

An operation in which a finger or a pen that has touched the touch panel 70a is released from the touch panel 70a, that is, an end of the touch (hereinafter, referred to as touch-up).

A state in which nothing touches the touch panel 70a (hereinafter, referred to as touch-off).

When the touch-down is detected, the touch-on is detected at the same time. After the touch-down, the touch-on is continuously detected normally unless the touch-up is detected. Also, when the touch-move is detected, the touch-on is continuously detected. Even if the touch-on is detected, the touch-move is not detected as long as the touch position is not moved. After detection of the touch-up of all the fingers and the pens that have touched the touch panel 70a, the state transitions to the touch-off.

The system control unit 50 is notified of these operations and states and position coordinates touched by a finger or a pen on the touch panel 70a via an internal bus. Then, the system control unit 50 determines, based on the notified information, what kind of operation (touch operation) has been executed on the touch panel 70a.

With regard to the touch-move, a movement direction of a finger or a pen moving on the touch panel 70a can be determined based on a change in the position coordinates for each vertical component and for each horizontal component on the touch panel 70a. When the touch-move for a predetermined distance or more is detected, it is determined that a sliding operation has been executed. An operation of quickly moving a finger by a certain distance while touching the touch panel 70a with the finger and releasing the finger from the touch panel 70a is referred to as a flick. In other words, the flick is an operation of quickly tracing the touch panel 70a so as to flick the touch panel 70a with a finger. When the touch-move at a predetermined speed or higher for a predetermined distance or more is detected and then the touch-up is detected, it can be determined that a flick has been executed (it can be determined that a flick has been executed following the sliding operation). Furthermore, a touch operation in which a plurality of places (for example, two points) are both touched (multi-touched) and the touch positions are brought close to each other is referred to as pinch-in, and a touch operation in which the touch positions are moved away from each other is referred to as pinch-out. The pinch-out and the pinch-in are collectively referred to as a pinch operation (or simply referred to as a pinch). The touch panel 70a may be any type of touch panel among various types such as a resistive film type, a capacitance type, a surface acoustic wave type, an infrared light type, an electromagnetic induction type, an image recognition type, and an optical sensor type. Although there are types including a type in which a touch is detected due to contact with the touch panel and a type in which a touch is detected due to approach of a finger or a pen to the touch panel, either of these types may be used.

The system control unit 50 can detect the following operations on the touch bar 82 or the following states of the touch bar 82.

An operation in which a finger that has not touched the touch bar 82 newly touches the touch bar 82, that is, a start of a touch (hereinafter, referred to as touch-down)

A state in which a finger is touching the touch bar 82 (hereinafter, referred to as touch-on)

An operation in which a finger is moving while touching the touch bar 82 (hereinafter, referred to as touch-move).

An operation in which a finger that has touched the touch bar 82 is released from the touch bar 82, that is, an end of the touch (hereinafter, referred to as touch-up)

A state in which nothing touches the touch bar 82 (hereinafter, referred to as touch-off).

When the touch-down is detected, the touch-on is detected at the same time. After the touch-down, the touch-on is continuously detected normally unless the touch-up is detected. Also, when the touch-move is detected, the touch-on is continuously detected. Even if the touch-on is detected, the touch-move is not detected as long as the touch position is not moved. After detection of the touch-up of all the fingers that have touched the touch bar 82, the state transitions to the touch-off.

These operations and states and the position coordinates of the finger on the touch bar 82 are notified to the system control unit 50 through an internal bus. Then, the system control unit 50 determines, based on the notified information, what kind of operation (touch operation) has been executed on the touch bar 82. As the touch-move, a movement of the finger on the touch bar 82 in the horizontal direction (left-right direction) is detected. When the touch-move for a predetermined distance or more is detected, it is determined that a sliding operation has been executed. When it is detected that a finger is released from the touch bar 82 within a predetermined period of time without executing the sliding operation after touching the touch bar 82 with the finger, it is determined that a tapping operation has been executed. When it is detected that the touch-on is continued for a period of time longer than the predetermined period of time without executing the sliding operation after touching the touch bar 82 with a finger, the touch bar 82 is continuously pressed with the finger. Therefore, it is determined that touch-hold has been executed.

The touch bar 82 may be any type of touch bars among various types such as a resistive film type, a capacitance type, a surface acoustic wave type, an infrared light type, an electromagnetic induction type, an image recognition type, and an optical sensor type.

A technique of the related art of fixing a display position of an item is disclosed. For example, the digital camera 100 where a position of the digital camera 100 on the grip portion 90 side and a position on the side opposite to the grip portion 90 side can be set is known. The position on the grip portion 90 side may be interpreted as a position on a right end side when the horizontal digital camera 100 is seen from a back side, and the position on the side opposite to the grip portion 90 side may be interpreted as a position on a left end side when the horizontal digital camera 100 is seen from the back side.

However, a suitable display position of an item depends on preference of a user. For example, the digital camera 100 may be used in the vertical orientation, and the suitable display position of the item may vary between the horizontal orientation and the vertical orientation. The digital camera 100 has a substantially quadrangular shape having a longitudinal direction (long side) and a transverse direction (short side) when seen from a shooting direction (an optical axis direction of the lens 103). The horizontal orientation is an orientation where the longitudinal direction is a left-right direction and the transverse direction is an up-down direction. The vertical orientation is an orientation where the longitudinal direction is the up-down direction and the transverse direction is the left-right direction, and is an orientation of the digital camera 100 where the horizontal digital camera 100 is rotated by 90 degrees or 270 degrees with respect to the shooting direction as an axis.

Here, the following users A and B are considered. A first direction and a second direction described below may be directions when the digital camera 100 is seen from the back side, or may be directions when the digital camera 100 is seen from a side that the display surface of the display device (the display unit 28 or the EVF 29) faces.

User A: a user who wants to display an item at a first position on an end side in the first direction that is the right direction or the left direction in the horizontal orientation, irrespective of the orientation of the digital camera 100.

User B: a user who wants to display the item at the first position in the horizontal orientation and, in the vertical orientation, who wants to display the item at a position on an end side in the second direction that is the up direction or the down direction in the vertical direction.

The vertical orientation includes a 90-degree vertical orientation corresponding to 90-degree rotation from the horizontal orientation and a 270-degree vertical orientation corresponding to 270-degree rotation from the horizontal orientation (vertical orientation that is vertically opposite to the 90-degree vertical orientation). Among the position on the end side in the second direction in the 90-degree vertical orientation and the position on the end side in the second direction in the 270-degree vertical orientation, one position is the first position, and the other position is a second position different from the first position.

Even when the orientation of the digital camera 100 changes, the method of holding the digital camera 100, for example, a method of holding the grip portion 90 with the little finger, the ring finger, or the middle finger of the right hand does not change in many cases. The user A is a user who thinks that it is important to maintain the operability of the item. For the user A, a case where the item is constantly displayed at the first position is considered. In this case, in one of the 90-degree vertical orientation and the 270-degree vertical orientation, the item is displayed at a position on the upper end side in the one vertical orientation. In the other one of the 90-degree vertical orientation and the 270-degree vertical orientation, the item is displayed at a position on the lower end side in the other one vertical orientation. Therefore, the visibility of the background (live view image) of the item varies between the 90-degree vertical orientation and the 270-degree vertical orientation. The user B is a user who thinks that the visibility of the background in the vertical orientation is important. For the user B, a case where the item is displayed at a position on an end side in the second direction in the vertical orientation is considered. In this case, a positional relationship between the item and the hand of the user varies between the 90-degree vertical orientation and the 270-degree vertical orientation, and the operability of the item varies.

In this way, the item display for the user A is not suitable for the user B, and the item display for the user B is not suitable for the user A. In addition, when the display position of the item can be set for each of the horizontal orientation, the 90-degree vertical orientation, and the 270-degree vertical orientation, the user operation for settings is complicated.

Accordingly, in the embodiment, the item can be reliably and easily displayed at a suitable position.

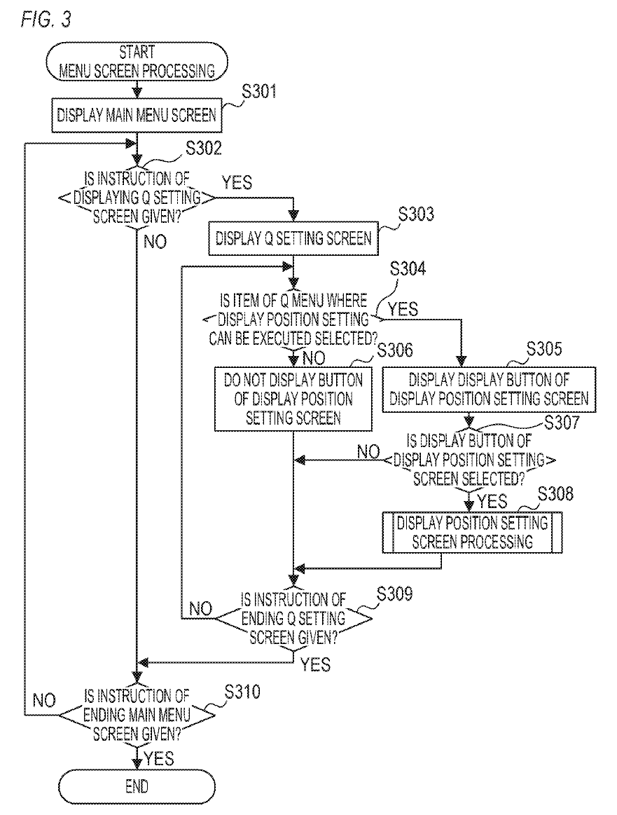

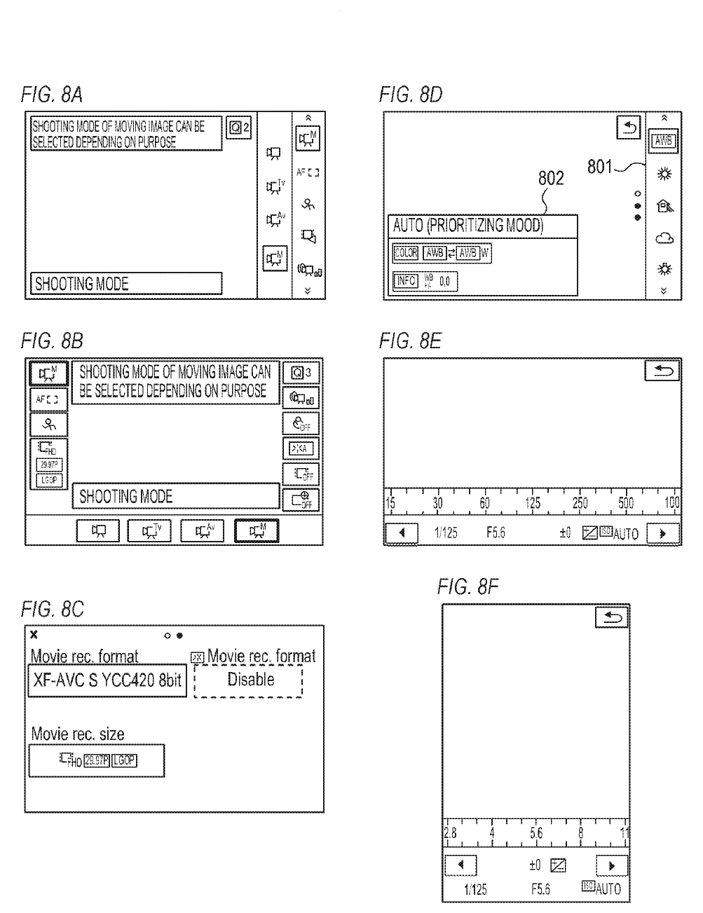

FIG. 3 is a flowchart illustrating menu screen processing according to the embodiment. The menu screen processing in FIG. 3 is implemented by the system control unit 50 loading a program stored in the non-volatile memory 56 into the system memory 52 and executing the program. For example, when the menu button 81 is pressed by the user or a predetermined item (GUI) is touched after the activation of the digital camera 100, the system control unit 50 starts the menu screen processing of FIG. 3. In addition, the item where the display position setting cannot be executed is not limited to the quick menus of the quick settings 2 and 3. The item where the display position setting cannot be executed may be an item where a plurality of display positions corresponding to a plurality of orientations of the digital camera 100 (a change in the display position depending on a change in the orientation of the digital camera 100) are predetermined as illustrated in FIGS. 8E and 8F. The item illustrated in FIGS. 8E and 8F is an exposure setting item. The item where the display position setting cannot be executed may be an item where the display position does not depend on the orientation of the digital camera 100.

In S301, the system control unit 50 causes the display unit 28 to display a main menu screen. The main menu screen includes menu items corresponding to the display of a quick setting screen.

In S302, the system control unit 50 determines whether a user operation of selecting the menu item corresponding to the display of the quick setting screen is executed. This user operation is, for example, the press of the SET button 75 or the touch on the menu item in a state where the menu item is selected. When the user operation of selecting the menu item corresponding to the display of the quick setting screen is executed, the process proceeds to S303. Otherwise, the process proceeds to S310.

In S303, the system control unit 50 causes the display unit 28 to display the quick setting screen. As a result, the screen to be displayed by the display unit 28 shifts from the main menu screen to the quick setting screen.

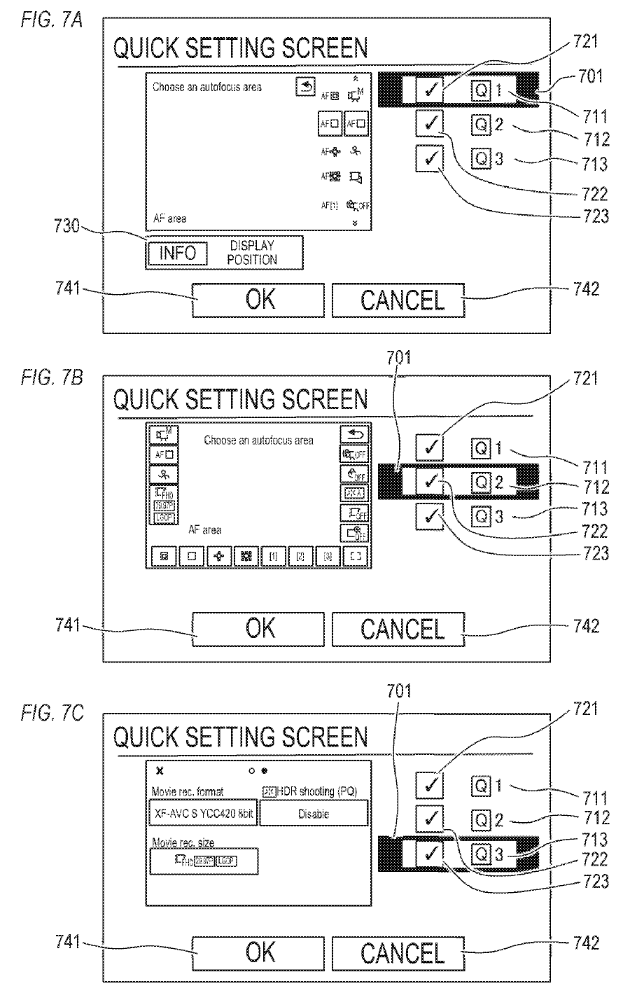

FIGS. 7A to 7C are schematic diagrams illustrating an example of the quick setting screen. In FIGS. 7A to 7C, using a cursor 701, any one of three setting items 711 to 713 (quick settings 1 to 3) corresponding to three quick menus, respectively, is selected. For example, the user can move the cursor 701 using the four-direction key 74. In addition, by touching any one of the setting items 711 to 713, the user can move the cursor 701 such that the touched selection item is shown (selected). The quick menu is called from a shooting screen in response to a predetermined button operation or a predetermined touch operation, and includes one or more setting items.

The setting items 711 to 713 (quick settings 1 to 3) are associated with check boxes 721 to 723, and the quick menu of the checked setting item can be called on the shooting screen. By pressing the SET button 75 in a state where any one of the setting items 711 to 713 is selected by the cursor 701, the user can check the check box of the selected setting item. In addition, by touching any one of the check boxes 721 to 723, the user can check the touched check box.

FIG. 7A illustrates a state where the setting item 711 (quick setting 1) is selected. In this case, when the calling operation of the quick menu is executed on the shooting screen, the quick menu screen illustrated in FIG. 8A is displayed. In the case of the quick setting 1, a plurality of setting items are displayed as the quick menu along one side of the screen. The quick menu may be interpreted as the item, or the setting item may be interpreted as the item. Regarding the quick menu of the quick setting 1, a display position setting (setting related to the display position) can be executed. Therefore, in FIG. 7A, a GUI button 730 (INFO button) corresponding to the display of the display position setting screen is displayed.

FIG. 7B illustrates a state where the setting item 712 (quick setting 2) is selected. In this case, when the calling operation of the quick menu is executed on the shooting screen, the quick menu screen illustrated in FIG. 8B is displayed. In the case of the quick setting 2, a plurality of setting items are displayed as the quick menu along two or more sides of the screen. Therefore, even when the display position of the quick menu of the quick setting 2 is changed, the visibility of the background (live view image) does not largely change. In addition, the quick menu of the quick setting 2 is a menu where an operation using both hands is assumed, and is a menu where the operability should be maintained. Due to the above-described reason, the display position setting cannot be executed for the quick menu of the quick setting 2. Therefore, in FIG. 7B, the GUI button 730 (INFO button) is not displayed.

FIG. 7C illustrates a state where the setting item 713 (quick setting 3) is selected. In this case, when the calling operation of the quick menu is executed on the shooting screen, the quick menu screen illustrated in FIG. 8C is displayed. The quick menu of the quick setting 1 and the quick menu of the quick setting 2 can be displayed to be superimposed on the live view image. However, the quick menu of the quick setting 3 cannot be displayed to be superimposed on the live view image, and can be displayed separately. Regarding the quick menu of the quick setting 3, the visibility of the live view image does not need to be regarded as important, and thus the display position setting cannot be executed. Therefore, in FIG. 7C, the GUI button 730 (INFO button) is not displayed.

The item where the display position setting can be executed is not limited to the quick menu of the quick setting 1. The item where the display position setting can be executed may be another menu including a plurality of setting items displayed along one side of the screen. The item where the display position setting can be executed may be another menu called from the quick menu of the quick setting 1. The item where the display position setting can be executed may be a WB setting menu 801 illustrated in FIG. 8D. In FIG. 8D, a sub-menu 802 related to the WB setting menu 801 is also displayed. The display position of the sub-menu 802 may change depending on a change in the display position of the WB setting menu 801.

In addition, the item where the display position setting cannot be executed is not limited to the quick menus of the quick settings 2 and 3. The item where the display position setting cannot be executed may be an item where a plurality of display positions corresponding to a plurality of orientations of the digital camera 100 (a change in the display position depending on a change in the orientation of the digital camera 100) are predetermined as illustrated in FIGS. 8E and 8F. The item illustrated in FIGS. 8E and 8F is an exposure setting item. The item where the display position setting cannot be executed may be an item where the display position does not depend on the orientation of the digital camera 100.

The description refers back to FIG. 3. In S304, the system control unit 50 determines whether the setting item 711 (quick setting 1) of the quick menu where the display position setting can be executed is selected. When the setting item 711 is selected, the process proceeds to S305. Otherwise, the process proceeds to S306.

In S305, the system control unit 50 displays the GUI button 730 (INFO button) corresponding to the display of the display position setting screen on the quick setting screen.

In S306, the system control unit 50 does not display the GUI button 730. When the GUI button 730 is not displayed, the system control unit 50 skips the processing of S306.

In S307, the system control unit 50 determines whether the user operation of selecting the GUI button 730 is executed. This user operation is, for example, the press of a predetermined button (INFO button) or the touch on the GUI button 730. When the user operation of selecting the GUI button 730 is executed, the process proceeds to S308. Otherwise, the process proceeds to S309.

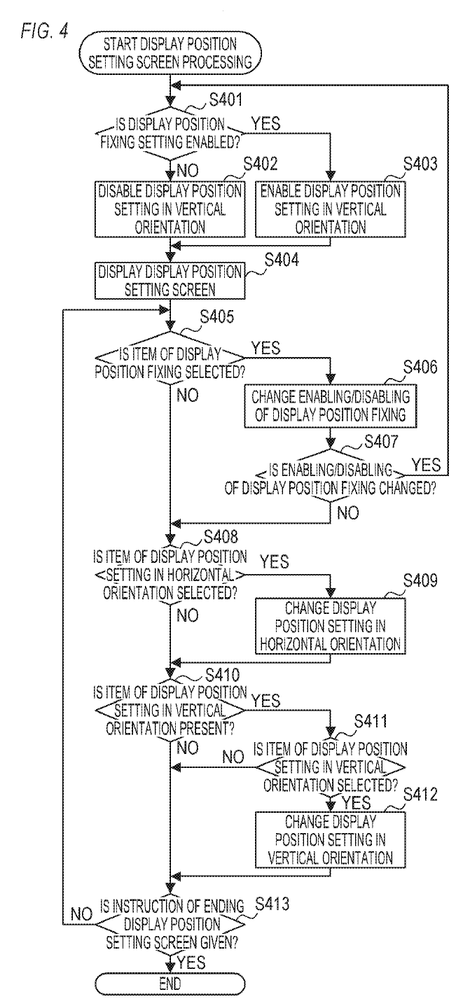

In S308, the system control unit 50 executes display position setting screen processing. The details of the display position setting screen processing will be described below using FIG. 4.

In S309, the system control unit 50 determines whether a user operation of ending the display of the quick setting screen is executed. This user operation is, for example, the press of the SET button 75 or the touch on an OK button 741 or a cancel button 742 in a state where the OK button 741 or the cancel button 742 of FIGS. 7A to 7C is selected by the cursor 701. When the user operation of ending the display of the quick setting screen is executed, the screen to be displayed by the display unit 28 is caused to return to the main menu screen from the quick setting screen, and the process proceeds to S310. Otherwise, the process proceeds to S304. When the user operation of ending the display of the quick setting screen is executed using the OK button 741, the system control unit 50 updates the callable quick menu according to the current state of the check boxes 721 to 723. When the user operation of ending the display of the quick setting screen is executed using the cancel button 742, the system control unit 50 does not update the callable quick menu.

In S310, the system control unit 50 determines whether a user operation of ending the display of the main menu screen is executed. This operation is, for example, the press of the menu button 81 or the touch on a predetermined item (GUI). When the user operation of ending the display of the main menu screen is executed, the menu screen processing of FIG. 3 ends. Otherwise, the process proceeds to S302.

FIG. 4 is a flowchart illustrating the display position setting screen processing that is executed in S308 of FIG. 3. The display position setting screen processing in FIG. 4 is implemented by the system control unit 50 loading a program stored in the non-volatile memory 56 into the system memory 52 and executing the program.

In the display position setting screen processing, the display position setting screen is displayed by the display unit 28. In the embodiment, a first setting and a second setting can be executed on the display position setting screen. A first direction and a second direction described below may be directions when the digital camera 100 is seen from the back side, or may be directions when the digital camera 100 is seen from a side that the display surface of the display device (the display unit 28 or the EVF 29) faces.

First setting: a setting where an item is displayed at a first position on an end side in the first direction that is the right direction or the left direction in the horizontal orientation, irrespective of the orientation of the digital camera 100 (a setting for the above-described user A; a setting where it is important to maintain the operability of the item).

Second setting: a setting where the item is displayed at the first position in the horizontal orientation and, in the vertical orientation, the item is displayed at a position on an end side in the second direction that is the up direction or the down direction in the vertical direction (a setting for the above-described user B; and a setting where the visibility of the background in the vertical orientation is important).

As described above, the vertical orientation includes a 90-degree vertical orientation corresponding to 90-degree rotation from the horizontal orientation and a 270-degree vertical orientation corresponding to 270-degree rotation from the horizontal orientation (vertical orientation that is vertically opposite to the 90-degree vertical orientation). Among the position on the end side in the second direction in the 90-degree vertical orientation and the position on the end side in the second direction in the 270-degree vertical orientation, one position is the first position, and the other position is a second position different from the first position.

In this way, in the embodiment, the first setting and the second setting can be executed. Therefore, the user A can display the item at the suitable position, and the user B can display the item at the suitable position. In addition, the display position of the item is not individually set for each of the 90-degree vertical orientation and the 270-degree vertical orientation, and thus the setting can be easily executed.

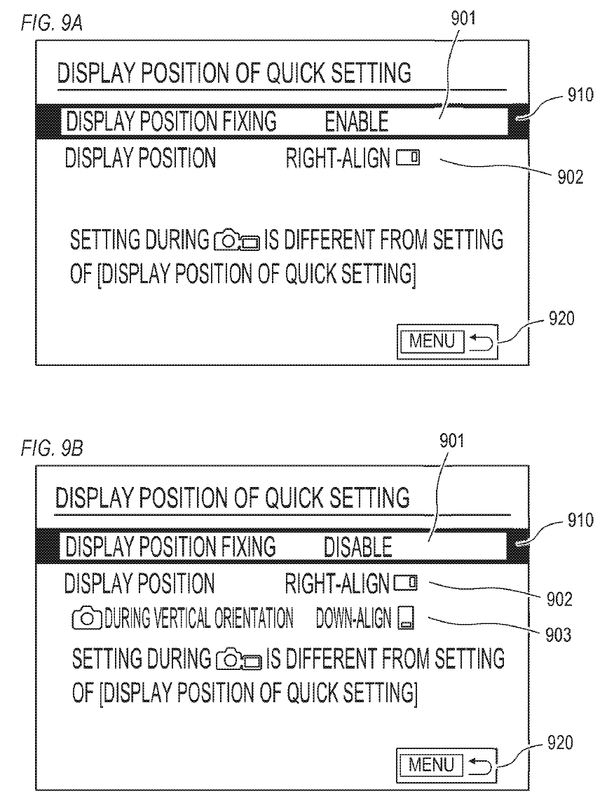

FIGS. 9A and 9B are schematic diagrams illustrating an example of the display position setting screen. The display position setting screen of FIGS. 9A and 9B includes setting items 901 and 902. The display position setting screen of FIG. 9B further includes a setting item 903. The setting item 901 is a setting item for designating whether to enable display position fixing of fixing the display position of the item in the 90-degree vertical orientation and the 270-degree vertical orientation to a position corresponding to the display position of the item in the horizontal orientation. The setting item 902 is a setting item for designating the display position of the item in the horizontal orientation, and the setting item 903 is a setting item for designating the display position of the item in the 90-degree vertical orientation and the 270-degree vertical orientation.

The setting item 901 has two options including “ENABLE” for enabling the display position fixing and “DISABLE” for disabling the display position fixing. The setting item 901 may be interpreted as a setting item for designating whether to enable or disable the setting item 902, or may be interpreted as a setting item for designating whether to enable the first setting or the second setting.

The case where the first setting is enabled is a case where “ENABLE” is selected. The case where the first setting is enabled may be interpreted as a case where the display position of the item in the horizontal orientation is designated by the setting item 902 and the display position of the item in the 90-degree vertical orientation and the 270-degree vertical orientation is not designated by the setting item 903. The case where the second setting is enabled is a case where “DISABLE” is selected. The case where the second setting is enabled may be interpreted as a case where the display position of the item in the horizontal orientation is designated by the setting item 902 and the display position of the item in the 90-degree vertical orientation and the 270-degree vertical orientation is designated by the setting item 903.

When “ENABLE” is selected, the first setting is enabled, and the setting item 902 is disabled. Therefore, in FIG. 9A, the setting item 902 is not displayed. The disabling of the setting item 902 may be indicated by gray-out or the like of the setting item 902.

The setting item 902 enables a designation corresponding to a configuration where the first direction is the right direction and a designation corresponding to a configuration where the first direction is the left direction. The setting item 902 has two options including “RIGHT-ALIGN” corresponding to the configuration where the first direction is the right direction and “LEFT-ALIGN” corresponding to the configuration where the first direction is the left direction. In order to easily understand the display position of the item in the horizontal orientation, the options of the setting item 902 may be options that represent the display position of the item in the horizontal orientation using members. For example, when the first direction is a direction when the digital camera 100 is seen from the back side, “GRIP SIDE” may be used instead of “RIGHT-ALIGN”, and “SIDE OPPOSITE TO GRIP SIDE” may be used instead of “LEFT-ALIGN”.

The setting item 903 enables a designation corresponding to a configuration where the second direction is the up direction and a designation corresponding to a configuration where the second direction is the down direction. The setting item 903 has two options including “UP-ALIGN” corresponding to the configuration where the second direction is the up direction and “DOWN-ALIGN” corresponding to the configuration where the second direction is the down direction.

The setting item 901 may be omitted and the setting item 903 may enable a designation corresponding to a configuration where the display position of the item in the 90-degree vertical orientation and the 270-degree vertical orientation is not designated. For example, the setting item 903 may include an option “CORRESPONDING TO DISPLAY POSITION IN HORIZONTAL ORIENTATION” of fixing the display position of the item in the 90-degree vertical orientation and the 270-degree vertical orientation to a position corresponding to the display position of the item in the horizontal orientation.

In S401, the system control unit 50 determines whether the display position fixing is enabled. When the display position fixing is enabled, the process proceeds to S402. Otherwise, the process proceeds to S403.

In S402, the system control unit 50 disables the setting (setting item 903) of the display position of the item in the vertical orientation (the 90-degree vertical orientation and the 270-degree vertical orientation).

In S403, the system control unit 50 enables the setting (setting item 903) of the display position of the item in the vertical orientation (the 90-degree vertical orientation and the 270-degree vertical orientation).

In step S404, the system control unit 50 causes the display unit 28 to display the display position setting screen. During the display of the display position setting screen, the display position setting screen is updated according to the processing result of S401 to S403.

In S405, the system control unit 50 determines whether the setting item 901 of the display position fixing is selected by a cursor 910. When the setting item 901 is selected, the process proceeds to S406. Otherwise, the process proceeds to S408.

In S406, the system control unit 50 changes the enabling/disabling of display position fixing (the state of the setting item 901) depending on the user operation. The user operation of changing the enabling/disabling of display position fixing includes, for example, the press of the SET button 75 or the touch on the setting item 901 in a state where the setting item 901 is selected by the cursor 910. When the user operation is not executed, the enabling/disabling of the display position fixing does not change.

In S407, the system control unit 50 determines whether the enabling/disabling of the display position fixing is changed. When the enabling/disabling of the display position fixing is changed, the process proceeds to S401. Otherwise, the process proceeds to S408.

In S408, the system control unit 50 determines whether the setting item 902 of the display position of the item in the horizontal orientation is selected by the cursor 910. When the setting item 902 is selected, the process proceeds to S409. Otherwise, the process proceeds to S410.

In S409, the system control unit 50 changes the setting (the state of the setting item 902) of the display position of the item in the horizontal orientation depending on the user operation. The user operation of changing the setting of the display position of the item in the horizontal orientation includes, for example, the press of the SET button 75 or the touch on the setting item 902 in a state where the setting item 902 is selected by the cursor 910.

In S410, the system control unit 50 determines whether the setting item 903 of the display position of the item in the vertical orientation (the 90-degree vertical orientation and the 270-degree vertical orientation) is displayed. When the setting item 903 is displayed, the process proceeds to S411. Otherwise, the process proceeds to S413.

In S411, the system control unit 50 determines whether the setting item 903 of the display position of the item in the vertical orientation (the 90-degree vertical orientation and the 270-degree vertical orientation) is selected by the cursor 910. When the setting item 903 is selected, the process proceeds to S412. Otherwise, the process proceeds to S413.

In S412, the system control unit 50 changes the setting (the state of the setting item 903) of the display position of the item in the vertical orientation (the 90-degree vertical orientation and the 270-degree vertical orientation) depending on the user operation. The user operation of changing the setting of the display position of the item in the vertical orientation includes, for example, the press of the SET button 75 or the touch on the setting item 903 in a state where the setting item 903 is selected by the cursor 910.

In S413, the system control unit 50 determines whether a user operation of ending the display of the display position setting screen is executed. This operation is, for example, the press of the menu button 81 or the touch on a GUI button 920. When the user operation of ending the display of the display position setting screen is executed, the display position setting screen processing of FIG. 4 ends. Otherwise, the process proceeds to S405. When the display position setting screen processing ends, the screen to be displayed by the display unit 28 returns from the display position setting screen to the quick setting screen.

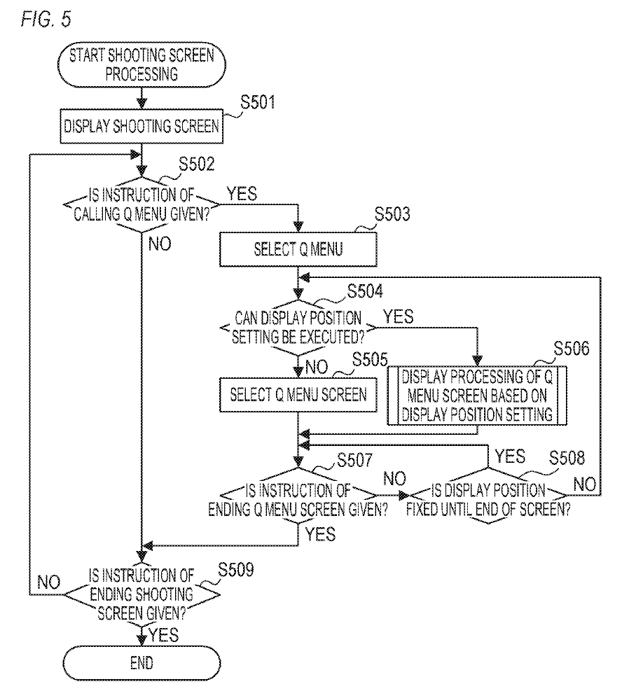

FIG. 5 is a flowchart illustrating shooting screen processing according to the embodiment. The shooting screen processing in FIG. 5 is implemented by the system control unit 50 loading a program stored in the non-volatile memory 56 into the system memory 52 and executing the program. For example, when the digital camera 100 is activated or the menu screen processing ends, the system control unit 50 starts the shooting screen processing of FIG. 5.

In S501, the system control unit 50 causes the display unit 28 to display the shooting screen. The shooting screen is a screen on which the live view image or items representing various shooting parameters can be displayed. The shooting screen may be displayed on the EVF 29.

In step S502, the system control unit 50 determines whether the calling operation of the quick menu is executed. When the calling operation is executed, the process proceeds to S503. Otherwise, the process proceeds to S509.

In S503, the system control unit 50 selects the quick menu to be called.

In S504, the system control unit 50 determines whether the display position setting can be executed for the quick menu to be called. When the display position setting can be executed, the process proceeds to S506. Otherwise, the process proceeds to S505.

In S505, the system control unit 50 causes the display unit 28 to display the quick menu screen including the quick menu to be called. As a result, the screen to be displayed by the display unit 28 shifts from the shooting screen to the quick menu screen. When the quick menu is called (during the display of the quick menu screen including the quick menu to be called), S505 is skipped.

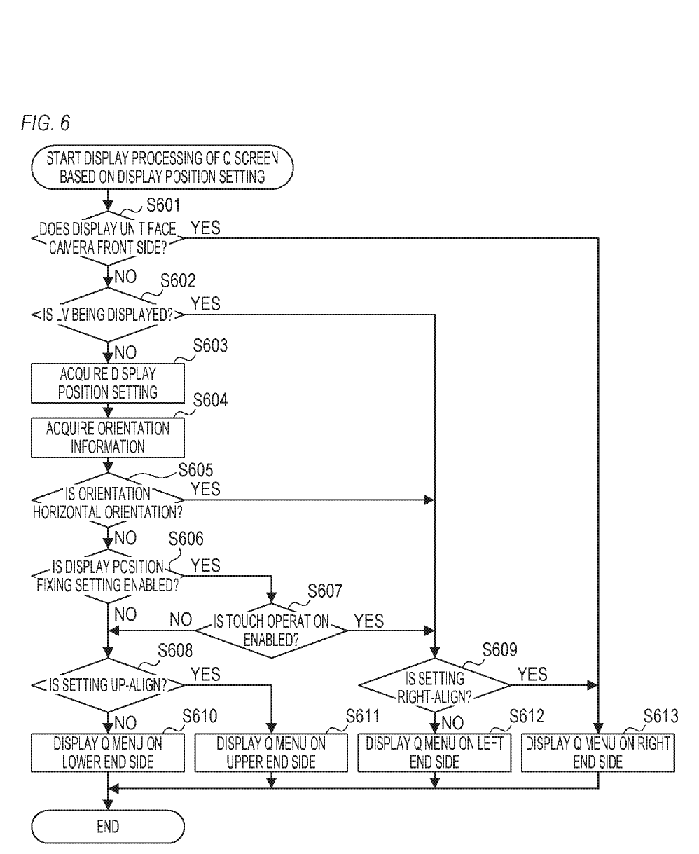

In S506, the system control unit 50 executes the display processing of the quick menu screen based on the display position setting. In the display processing of the quick menu screen based on the display position setting, orientation information (for example, the detection result of the orientation detection unit 55) regarding the orientation of the digital camera 100 is acquired. In the display unit 28, the quick menu (item) is displayed at the display position based on the orientation information and the display position setting. The details of the display processing will be described below using FIG. 6.

In S507, the system control unit 50 determines whether a user operation of ending the display of the quick menu screen is executed. This operation is, for example, a predetermined button operation or a predetermined touch operation. When the user operation of ending the display of the quick menu screen is executed, the screen to be displayed by the display unit 28 is caused to return to the shooting screen from the quick menu screen, and the process proceeds to S509. Otherwise, the process proceeds to S508.

In S508, the system control unit 50 determines whether to fix the display position of the quick menu screen until the display of the quick menu screen ends. When the display position of the quick menu screen is fixed, the process proceeds to S507. Otherwise, the process proceeds to S504. Whether to fix the display position of the quick menu screen until the display of the quick menu screen ends is previously designated, for example, by the user. Whether to fix the display position of the quick menu screen until the display of the quick menu screen ends may be designated individually for each of a plurality of quick menus or may be designated as a common feature to the plurality of quick menus. Whether to fix the display position of the quick menu screen until the display of the quick menu screen ends may be previously designated by a manufacturer or the like for each quick menu. The process may skip S508 and proceed to S504.

In S509, the system control unit 50 determines whether a user operation of ending the display of the shooting screen is executed. This operation is, for example, a user operation of turning off the digital camera 100 or a user operation of calling the main menu screen, and is, for example, a predetermined button operation or a predetermined touch operation. When the user operation of ending the display of the shooting screen is executed, the shooting screen processing of FIG. 5 ends. Otherwise, the process proceeds to S502.

When a plurality of quick menus are callable, the quick menu to be called can be switched, for example, by repeating the calling operation.

FIG. 6 is a flowchart illustrating the display processing of the quick menu screen based on the display position setting that is executed in S506 of FIG. 5. The display processing in FIG. 6 is implemented by the system control unit 50 loading a program stored in the non-volatile memory 56 into the system memory 52 and executing the program.

In S601, the system control unit 50 determines whether the display surface of the display unit 28 faces the front side of the digital camera 100. When the display surface of the display unit 28 faces the front side of the digital camera 100, the process proceeds to S613. Otherwise, the process proceeds to S602.

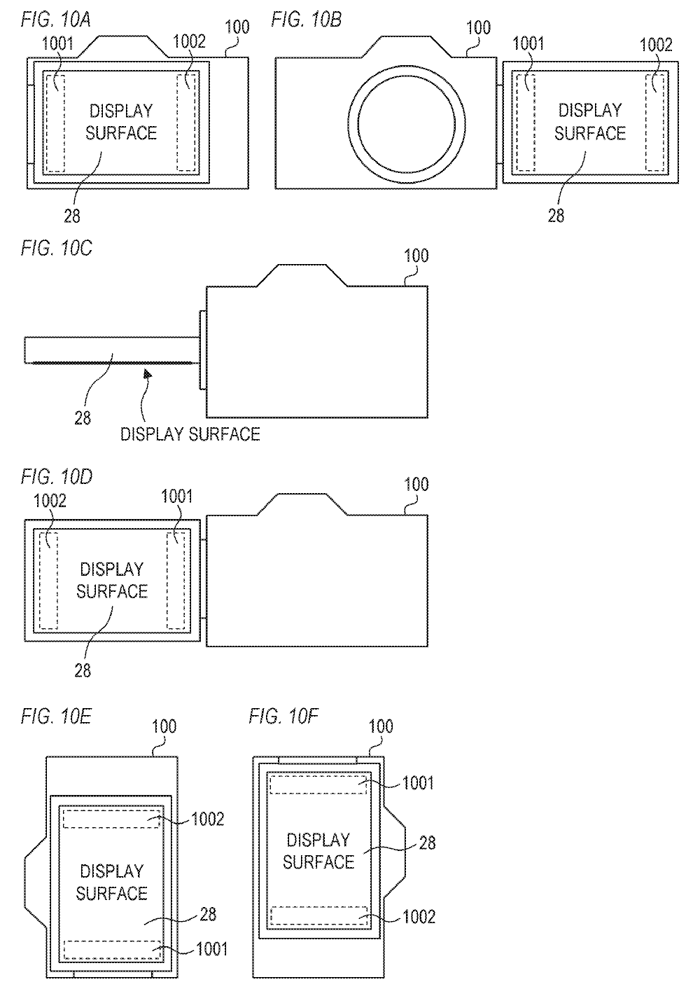

In the embodiment, the orientation of the display unit 28 with respect to a body portion of the digital camera 100 is changeable. A case where the orientation of the digital camera 100 is the horizontal orientation, the orientation of the display unit 28 is the orientation illustrated in FIG. 1B, and the digital camera 100 is seen from the back side is assumed. A center portion of a left surface (surface on the left side) of the display unit 28 is connected to a portion of the left surface of the body portion that is close to the back surface and is substantially at the center in the up-down direction. The display unit 28 is rotatable about the connection portion with respect to the up-down direction and the left-right direction as the axes. Therefore, the display unit 28 can adopt various orientations including orientations illustrated in FIGS. 10A to 10D. The orientation of FIG. 10A is the same as the orientation of FIG. 1B, and the display surface of the display unit 28 faces the back side. The orientation of FIG. 10B is an orientation obtained by rotating the display unit 28 by 180 degrees from the orientation of FIG. 10A with respect to the up-down direction as the axis, and the display surface faces the front side. The orientation of FIG. 10C is an orientation obtained by rotating the display unit 28 by 90 degrees from the orientation of FIG. 10B with respect to the left-right direction as the axis, and the display surface faces downward. The orientation of FIG. 10D is an orientation obtained by rotating the display unit 28 by 90 degrees from the orientation of FIG. 10C with respect to the left-right direction as the axis, and the display surface faces the back side. Although not illustrated in the drawing, the display surface may also face upward. FIGS. 10A to 10D illustrate the horizontal orientations of the digital camera 100.

In S602, the system control unit 50 determines whether the live view image is being displayed. The display/non-display of the live view image can be switched by a user operation. When the live view image is being displayed, the process proceeds to S603. Otherwise, the process proceeds to S609. When the quick menu is displayed without displaying the live view image, the visibility of the live view image does not need to be regarded as important. In a case where the live view image is not displayed by executing the determination of S602, even when the above-described second setting is executed, the quick menu is displayed at the above-described first position, irrespective of the orientation of the digital camera 100.

In S603, the system control unit 50 acquires parameters (setting values) of the display position setting.

In S604, the system control unit 50 acquires the orientation information (for example, the detection result of the orientation detection unit 55) regarding the orientation of the digital camera 100.

In S605, the system control unit 50 determines whether the orientation of the digital camera 100 is the horizontal orientation or the vertical orientation based on the orientation information acquired in S604. When the orientation of the digital camera 100 is the horizontal orientation, the process proceeds to S609. Otherwise (in the vertical orientation), the process proceeds to S606.

In S606, the system control unit 50 determines whether the display position fixing is enabled (the state of the setting item 901 is “ENABLE”). When the display position fixing is enabled, the process proceeds to S607. Otherwise, the process proceeds to S608.

In S607, the system control unit 50 determines whether the touch operation on the display surface (touch panel 70a) of the display unit 28 is enabled (whether a reception state of the touch operation is an enabled state where the reception of the touch operation is enabled or a disabled state where the reception of the touch operation is disabled). The enabling/disabling of the touch operation can be switched by the user operation. When the touch operation is enabled, the process proceeds to S609. Otherwise, the process proceeds to S608. When the touch operation is disabled, the operability of the quick menu does not need to be regarded as important, and it is preferable to regard the visibility of the live view image as important. When the touch operation is disabled after executing the determination of S607, even when the above-described first setting is executed, the quick menu is displayed at a position corresponding to the above-described second setting.

When the touch operation is enabled, the operability of the quick menu is regarded as important, and the quick menu may be displayed at a position corresponding to the first setting even when the second setting is executed. For example, when the display position fixing is enabled, the determination of S607 is not executed. When the display position fixing is disabled, the determination of S607 is executed. When the touch operation is enabled, the process may proceed to S609. Otherwise, the process may proceed to S608.

In S608, the system control unit 50 determines whether the setting (the state of the setting item 903) of the display position of the item in the vertical orientation (the 90-degree vertical orientation and the 270-degree vertical orientation) is “UP-ALIGN”. When the setting of the display position of the item in the vertical orientation is “UP-ALIGN”, the process proceeds to S611. Otherwise (“DOWN-ALIGN”), the process proceeds to S610.

In S609, the system control unit 50 determines whether the setting (the state of the setting item 902) of the display position of the item in the horizontal orientation is “RIGHT-ALIGN”. When the setting of the display position of the item in the horizontal orientation is “RIGHT-ALIGN”, the process proceeds to S613. Otherwise (“LEFT-ALIGN”), the process proceeds to S612.

In S610, the system control unit 50 causes the display unit 28 to display the quick menu screen where the quick menu is located on the lower end side (position on the lower end side in the current orientation of the digital camera 100). FIG. 10E illustrates a 90-degree vertical orientation where the digital camera 100 is rotated by 90 degrees to the left (counterclockwise) from the state of FIG. 10A when the digital camera 100 is seen from a side that the display surface of the display unit 28 faces. FIG. 10F illustrates a 270-degree vertical orientation where the digital camera 100 is rotated by 270 degrees to the left (counterclockwise) from the state of FIG. 10A when the digital camera 100 is seen from the side that the display surface of the display unit 28 faces. In S610, the quick menu is displayed at a position bin the 90-degree vertical orientation of FIG. 10E, and the quick menu is displayed at a position 1002 in the 270-degree vertical orientation of FIG. 10F.

In S611, the system control unit 50 causes the display unit 28 to display the quick menu screen where the quick menu is located on the upper end side (position on the upper end side in the current orientation of the digital camera 100). The quick menu is displayed at the position 1002 in the 90-degree vertical orientation of FIG. 10E, and the quick menu is displayed at the position 1001 in the 270-degree vertical orientation of FIG. 10F.

In S612, the system control unit 50 causes the display unit 28 to display the quick menu screen where the quick menu is located on the left end side (position on the left end side in the current orientation of the digital camera 100). Here, a case where the digital camera 100 is seen from the side that the display surface of the display unit 28 faces is assumed. The quick menu is displayed at a position 1101 in the horizontal orientation of FIG. 10A, and the quick menu is displayed at a position 1102 in the horizontal orientation of FIG. 10D.

In S613, the system control unit 50 causes the display unit 28 to display the quick menu screen where the quick menu is located on the right end side (position on the right end side in the current orientation of the digital camera 100). Here, a case where the digital camera 100 is seen from the side that the display surface of the display unit 28 faces is assumed. The quick menu is displayed at the position 1102 in the horizontal orientation of FIG. 10A, and the quick menu is displayed at the position 1101 in the horizontal orientation of FIG. 10D.

As described above, when the display surface of the display unit 28 faces the front side of the digital camera 100, the process proceeds from S601 to S613. When the display surface of the display unit 28 faces the front side of the digital camera 100, the operability of the touch operation on a portion (the position 1001 of FIG. 10B) close to the body portion of the digital camera 100 on the display surface decreases due to the body portion. Therefore, the process proceeds from S601 to S613, and the quick menu is displayed in a portion (the position 1002 of FIG. 10B) distant from the body portion of the digital camera 100. The same also applies to the case of FIG. 10C where the display surface faces downward.

An obstacle that decreases the operability of the touch operation on the display surface of the display unit 28 is not limited to the body portion of the digital camera 100. When the obstacle is present in the vicinity of one of the first position and the second position described above, the quick menu may be displayed at the other one of the first position and the second position, irrespective of the orientation information and the display position setting.

In addition, whether the digital camera 100 is fixed by a tripod or the like may be detectable. In a case where the digital camera 100 is fixed by the tripod or the like, even when the obstacle is present in the vicinity of the one display position, the quick menu may be displayed at a position based on the orientation information and the display position setting (position corresponding to the display position setting).

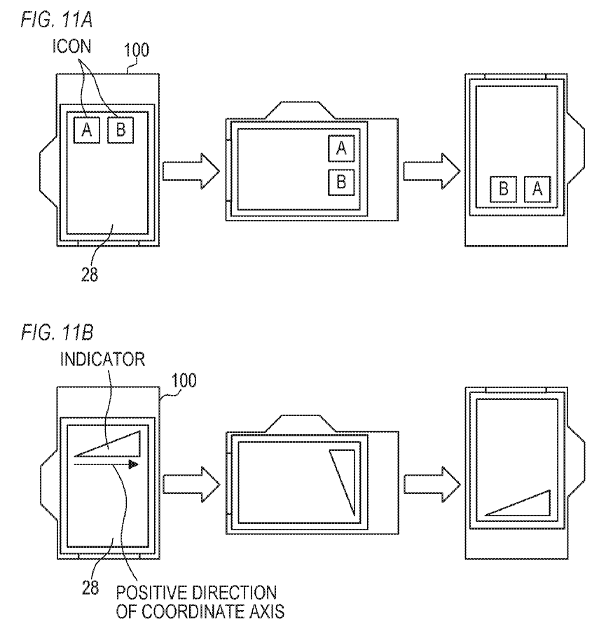

As illustrated in FIG. 11A, when the quick menu is displayed, the system control unit 50 may rotate the icon in the quick menu such that the icon faces the up direction in the current orientation of the digital camera 100. The quick menu may include an indicator indicating a value using a coordinate axis. As illustrated in FIG. 11B, in the horizontal orientation, the system control unit 50 may execute a control such that a positive direction of the coordinate axis of the indicator substantially matches with the up direction in the horizontal orientation. The system control unit 50 may execute a control such that, in the 90-degree vertical orientation, the positive direction of the coordinate axis of the indicator substantially matches with the right direction in the 90-degree vertical orientation and, in the 270-degree vertical orientation, the positive direction of the coordinate axis of the indicator substantially matches with the right direction in the 270-degree vertical orientation. In the horizontal orientation, the system control unit 50 may execute a control such that a positive direction of the coordinate axis of the indicator substantially matches with the down direction in the horizontal orientation. The system control unit 50 may execute a control such that, in the 90-degree vertical orientation, the positive direction of the coordinate axis of the indicator substantially matches with the left direction in the 90-degree vertical orientation and, in the 270-degree vertical orientation, the positive direction of the coordinate axis of the indicator substantially matches with the left direction in the 270-degree vertical orientation.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, an item can be reliably and easily displayed at a suitable position.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

In the above-described embodiment, the case where the present disclosure is applied to the imaging device has been described as an example, but the present disclosure is not limited to the imaging device, and can be applied to any electronic device capable of performing display control of an image. For example, the present disclosure is applicable to a personal computer, a PDA, a mobile phone terminal, a portable image viewer, a printer apparatus, a digital photo frame, a music player, a game console, and an electronic book reader. The present disclosure is also applicable to a video player, a display device (including a projection device), a tablet terminal, a smartphone, an AI speaker, a home appliance, and an in-vehicle device.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-015885, filed Feb. 3, 2025, which is hereby incorporated by reference herein in its entirety.

What is claimed is:

1. An electronic device that includes a display device, the electronic device comprising:
a processor; and
a memory storing a program which, when executed by the processor, causes the electronic device to
execute acquisition processing of acquiring information regarding an orientation of the electronic device,
execute setting processing of performing setting regarding a display position of an item, and
execute control processing of performing control such that the item is displayed at a position of the display device based on the information acquired by the acquisition processing and the setting performed by the setting processing, wherein
in the setting processing, it is capable of performing a first setting in which (1) in a first state where the electronic device is in a horizontal orientation, the item is displayed at a first position on an end side in a first direction that is a right direction or a left direction in the first state, (2) in a second state where the electronic device is in a first vertical orientation, the item is displayed at the first position on an end side in a second direction that is an up direction or a down direction in the second state, and (3) in a third state where the electronic device is in a second vertical orientation that is vertically opposite to the first vertical orientation, the item is displayed at a second position on an end side in the second direction in the third state.

2. The electronic device according to claim 1, wherein in the setting processing, it is capable of a second setting in which the item is displayed at the first position, irrespective of the orientation of the electronic device.

3. The electronic device according to claim 2, wherein
in the control processing, it is capable of performing control such that the display device displays a setting screen for the setting performed by the setting processing,
the setting screen includes a first setting item for designating the display position of the item in the first state and a second setting item for designating the display position of the item in the second state and the third state,
the first setting item enables a designation corresponding to a configuration where the first direction is the right direction and a designation corresponding to a configuration where the first direction is the left direction, and
the second setting item enables a designation corresponding to a configuration where the second direction is the up direction and a designation corresponding to a configuration where the second direction is the down direction.

4. The electronic device according to claim 3, wherein
in a case where the display position of the item in the first state is designated by the first setting item and the display position of the item in the second state and the third state is not designated by the second setting item, the second setting is performed in the setting processing, and
in a case where the display position of the item in the first state is designated by the first setting item and the display position of the item in the second state and the third state is designated by the second setting item, the first setting is performed in the setting processing.

5. The electronic device according to claim 3, wherein the second setting item further enables a designation corresponding to a configuration where the display position of the item in the second state and the third state is not designated.

6. The electronic device according to claim 3, wherein the setting screen further includes a third setting item for designating whether to enable or disable the second setting item.

7. The electronic device according to claim 6, wherein in a case where the disabling of the second setting item is designated by the third setting item, the control processing performs control such that the second setting item is not displayed.

8. The electronic device according to claim 1,
wherein the item includes an icon, and
in the control processing, control is performed such that the icon faces an up direction in a current orientation of the electronic device.

9. The electronic device according to claim 1,
wherein the item includes an indicator indicating a value using a coordinate axis, and
in the control processing, control is performed such that (1) in the first state, a positive direction of the coordinate axis of the indicator substantially matches with a third direction that is an up direction or a down direction in the first state, (2) in the second state, the positive direction of the coordinate axis of the indicator substantially matches with a fourth direction that is a right direction or a left direction in the second state, and (3) in the third state, the positive direction of the coordinate axis of the indicator substantially matches with the fourth direction in the third state.

10. The electronic device according to claim 1,
wherein in the control processing, it is capable of performing control such that the item is displayed to be superimposed on a live view image, and
in a case where the item is displayed without displaying the live view image, in the control processing, control is performed such that the item is displayed at the first position, irrespective of the orientation of the electronic device even if the first setting is performed.

11. The electronic device according to claim 2,
wherein a reception state of a touch operation on a display surface of the display device is capable of being switched between an enabled state where reception of the touch operation is enabled and a disabled state where the reception of the touch operation is disabled, and
in a case where the reception state of the touch operation is in the disabled state, in the control processing, control is performed such that the item is displayed at the first position in the first state, the item is displayed at the first position in the second state, and the item is displayed at the second position in the third state even if the second setting is performed.

12. The electronic device according to claim 1, wherein in a case where an obstacle that decreases operability of a touch operation on a display surface of the display device is present in the vicinity of one of the first position and the second position, in the control processing, control is performed such that the item is displayed at the other one of the first position and the second position irrespective of the information acquired by the acquisition processing and the setting performed by the setting processing.

13. The electronic device according to claim 12,
wherein the electronic device is an imaging device,
an orientation of the display device relative to the electronic device is changeable, and
the case where the obstacle is present in the vicinity of the one position includes a case where the display surface faces a front side of the electronic device.

14. The electronic device according to claim 12, wherein in a case where the obstacle is present in the vicinity of the one position but the electronic device is fixed, in the control processing, control is performed such that the item is displayed at the position based on the information acquired by the acquisition processing and the setting performed by the setting processing.

15. The electronic device according to claim 1, wherein in the control processing, control is performed such that
when display of the item starts, the item is displayed at the position based on the information acquired by the acquisition processing and the setting performed by the setting processing, and
even if there is a change in the information acquired by the acquisition processing and the setting performed by the setting processing during the display of the item, the display position of the item does not change.

16. The electronic device according to claim 3, wherein the first setting item includes options that represent the display position of the item in the first state using members as an option for performing the designation corresponding to the configuration where the first direction is the right direction and an option for performing the designation corresponding to the configuration where the first direction is the left direction, and
the second setting item includes options that represent the display position of the item in the second state and the third state using directions as an option for performing the designation corresponding to the configuration where the second direction is the up direction and an option for performing the designation corresponding to the configuration where the second direction is the down direction.

17. A control method of an electronic device that includes a display device, the control method comprising:
acquiring information regarding an orientation of the electronic device;
performing setting regarding a display position of an item; and
performing control such that the item is displayed at a position of the display device based on the information and the setting, wherein
it is capable of performing a first setting in which (1) in a first state where the electronic device is in a horizontal orientation, the item is displayed at a first position on an end side in a first direction that is a right direction or a left direction in the first state, (2) in a second state where the electronic device is in a first vertical orientation, the item is displayed at the first position on an end side in a second direction that is an up direction or a down direction in the second state, and (3) in a third state where the electronic device is in a second vertical orientation that is vertically opposite to the first vertical orientation, the item is displayed at a second position on an end side in the second direction in the third state.

18. A non-transitory computer readable medium that stores a program, wherein the program causes a computer to execute a control method of an electronic device that includes a display device, the control method comprising:
acquiring information regarding an orientation of the electronic device;
performing setting regarding a display position of an item; and
performing control such that the item is displayed at a position of the display device based on the information and the setting, wherein
it is capable of performing a first setting in which (1) in a first state where the electronic device is in a horizontal orientation, the item is displayed at a first position on an end side in a first direction that is a right direction or a left direction in the first state, (2) in a second state where the electronic device is in a first vertical orientation, the item is displayed at the first position on an end side in a second direction that is an up direction or a down direction in the second state, and (3) in a third state where the electronic device is in a second vertical orientation that is vertically opposite to the first vertical orientation, the item is displayed at a second position on an end side in the second direction in the third state.
